(19) United States
(12) Patent Application Publication
(10) Pub. No.: US 2016/0339570 A1
(43) Pub. Date: Nov. 24, 2016

(54) FASTENING UNIT

(71) Applicant: YU-TU HSU, Taichung (TW)

(72) Inventor: YU-TU HSU, Taichung (TW)

(21) Appl. No.: 14/716,894

(22) Filed: May 20, 2015

(51) Int. Cl. B25B 23/10; B25B 13/46

(52) U.S. Cl. CPC B25B 23/108; B25B 13/46

(57) ABSTRACT

A fastening unit includes a body having a driving end and a connection end. The driving end has a driving recess for receiving a nut therein, and the connection end has an engaging recess for being connected with a driving portion of a ratchet wrench. The driving recess has a first slot and a second slot respectively defined in the inside thereof, and the first and second slot extend along the X-axis of the body. An annular groove is defined in the inner periphery of the inner end of the driving recess. A resilient member has a spiral and cylindrical portion. The resilient member has an extension end and a protrusion protrudes laterally from the extension end so that the protrusion applies a resilient force along the Y-axis of the body. The fastening unit firmly position the nut therein.

### BACKGROUND OF THE INVENTION

1. Fields of the Invention

The present invention relates to a fastening unit, and more particularly, to a fastening unit to fasten a nut to a bottom of a bolt without free rotation.

2. Descriptions of Related Art

The conventional fastening unit 10 is disclosed in FIG. 1 and the fastening unit 10 has a driving end 11 and a connection end 12. The driving end 11 has a hexagonal recess 111 for receiving a nut 22 therein, and the connection end 12 has a rectangular recess 121 for being connected with a driving portion 21 of a ratchet wrench 20. By repeatedly rotating the ratchet wrench 20, the fastening unit 10 is rotated in one direction and the nut 22 is threadedly moved along the bottom of the shank of the bolt 23.

However, there is a tolerance between the male threads 221 of the nut 22 and the female threads 231 of the bolt 23. More specifically, the as shown in FIG. 2, the teeth of the male threads are made to be tapered teeth 222, and the width between two adjacent teeth of the female threads 231 is made to be wider enough so as to easily accommodate the teeth of the male threads 221. Nevertheless, when the male threads 221 are engaged with the female threads 231, because the tolerance, the friction between the male threads 221 and the female threads 231 is not sufficient. The nut 22 will be repeatedly rotated with the fastening unit 10 back and forth. Therefore, when threading a nut 22 to a bolt 23, the user usually rotates the nut 22 by hand until the nut 22 is moved to a position close to the root portion of the shank of the bolt 23, and then using the fastening unit 10 to fasten the nut 22 to the root portion of the bolt 23. This is not convenient for the user especially when the user's hand has grease attached thereon.

FIGS. 3 and 3 show that a piece 30 made of soft material is first inserted in recess 33 of the fastening unit 32, and the piece 30 has a hole 301 and a ring shaped magnet 31 is engaged with the hole 301. The nut 34 is then engaged with the recess 33 of the fastening unit 32 and magnetically attracted by the magnet 31 of the piece 30. Therefore, when the fastening unit 32 is cooperated with a ratchet wrench 35, the nut 34 can be stayed in the fastening unit 32.

However, the nut 34 has to be positioned in a certain depth of the recess 33 of the fastening unit 32 such that the nut 34 is magnetically attracted by the magnet 31 of the piece 30.

Besides, when the bolt 36 has a long shank, the nut 34 cannot be threadedly connected to the root portion of the shank of the bolt 36 because the piece 34 restricts the depth of the recess 33 of the fastening unit 32 that the shank of the bolt 36 can reach. When magnetic feature of the magnet 31 weakened, the nut 34 cannot be attracted properly. The piece 34 together the magnet 31 increase the cost of the fastening unit 32. The magnetic force applied along the axis of the nut 34 may not ensure a sufficient friction.

FIGS. 5 and 6 show another fastening unit which comprises a body 40, a piece 41, a magnet 42, a spring 43 and a clip 44. The clip 44 positions the magnet 42 in the piece 41, and the spring 43 is located in the body 40.

Although the magnet 42 and the piece 41 each have a hole 411/421 so as to allow a longer shank 451 of a bolt 45, a high manufacturing cost does not meet market needs. The magnet 42 is more complicated and has the same shortcoming as mentioned above. Moreover, the parts are too many to obtain an economic and simple fastening unit. Again, the magnet 42 and the spring 43 all apply a force along the X axis.

The present invention intends to provide a fastening unit to eliminate the shortcomings mentioned above.

### SUMMARY OF THE INVENTION

The present invention relates to a fastening unit and comprises a body having a driving end and a connection end. The driving end has a driving recess for receiving a nut therein, and the connection end has an engaging recess for being connected with a driving portion of a ratchet wrench. The driving recess has a first slot and a second slot respectively defined in the inside thereof, and the first and second slot extend along the X-axis of the body. An annular groove is defined in the inner periphery of the inner end of the driving recess. A resilient member has a spiral and cylindrical portion. The resilient member has an extension end and a protrusion protrudes laterally from the extension end so that the protrusion applies a resilient force along the Y-axis of the body. The fastening unit firmly position the nut therein.

Preferably, the minimum diameter of the spiral and cylindrical portion is equal to or larger than the diameter of a shank of a bolt.

The present invention also provides the second embodiment of the fastening unit which comprises a body having a driving end and a connection end respectively on two ends thereof. The driving end has a driving recess defined therein so as to receive a nut therein. The connection end has an engaging recess defined therein. The driving recess has a first slot defined in the inside thereof and the first slot extends along the X-axis of the body. An annular groove is defined in the inner periphery of the inner end of the driving recess. A second slot is defined in the inside of the driving recess and the second slot extends along the X-axis of the body.

A first resilient member has a spiral and cylindrical portion. One end of the spiral and cylindrical portion is engaged with the annular groove. The first resilient member applies a resilient force along the X-axis of the body. A second resilient member has a first part and a second part whose one end is connected to one end of the first part at an angle. The first part of the second resilient member inserted in the second slot, and the second part applies a resilient force along the Y-axis of the body.

Preferably, the minimum diameter of the spiral and cylindrical portion of the first resilient member is equal to or larger than the diameter of a shank of a bolt.

The present invention also provides the second embodiment of the fastening unit which comprises a body having a driving end and a connection end 52 respectively on two ends thereof. The driving end has a driving recess defined therein. The connection end has an engaging recess defined therein which is connected with a driving portion of a ratchet wrench. The driving recess has a first slot and a second slot defined in the inside thereof. The first slot 51 extends along the X-axis of the body. An annular groove is defined in the inner periphery of the inner end of the driving recess. A resilient member has a C-shaped portion which has an extension end and a distal end. The extension end has a protrusion protruding laterally from the extension end. The distal end applies a resilient force along the X-axis of the body. The extension end is a resilient end and the protrusion applies a resilient force along the Y-axis of the body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the conventional fastening unit fastening a nut to a bolt;

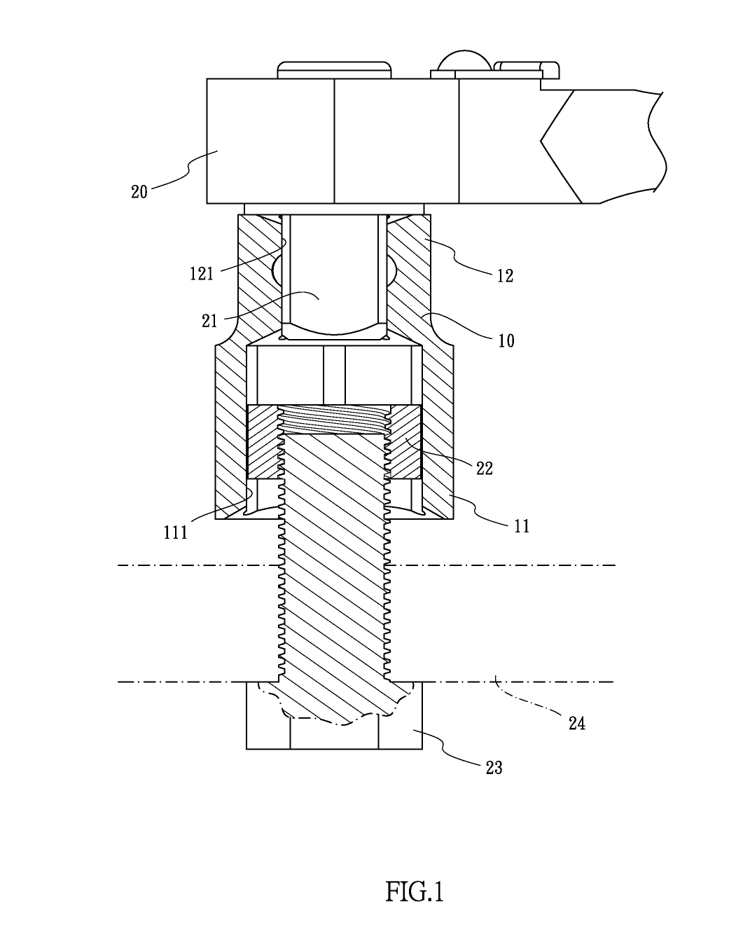

FIG. 2 is an enlarged and cross sectional view to show engagement between threads of the nut and the bolt when using the conventional fastening unit to fasten the nut to the bolt;

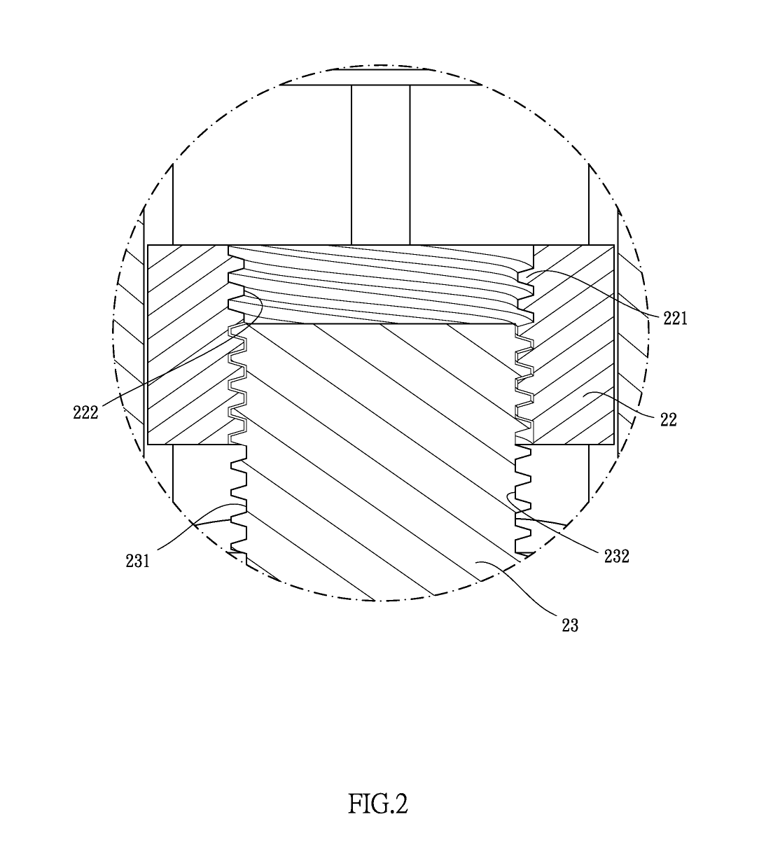

FIG. 3 shows another conventional fastening unit;

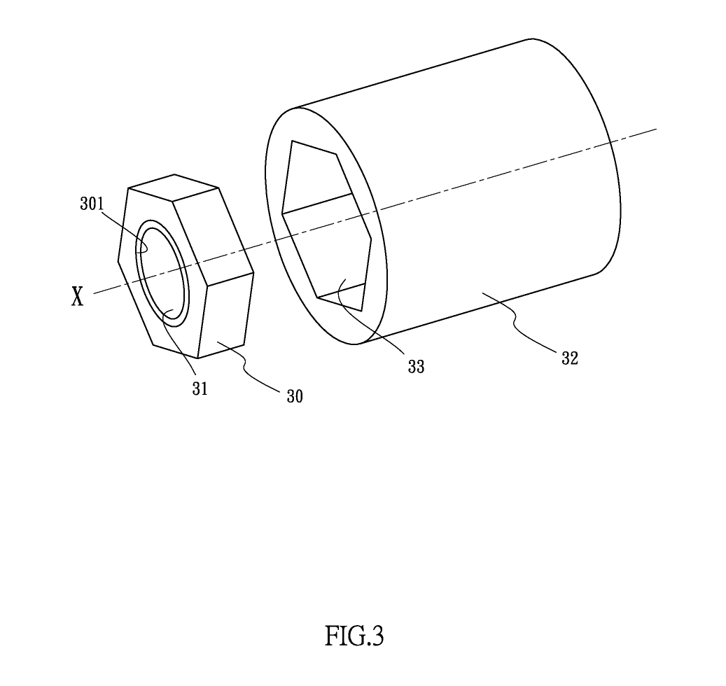

FIG. 4 is an exploded view of the conventional fastening unit in FIG. 3 and a ratchet wrench;

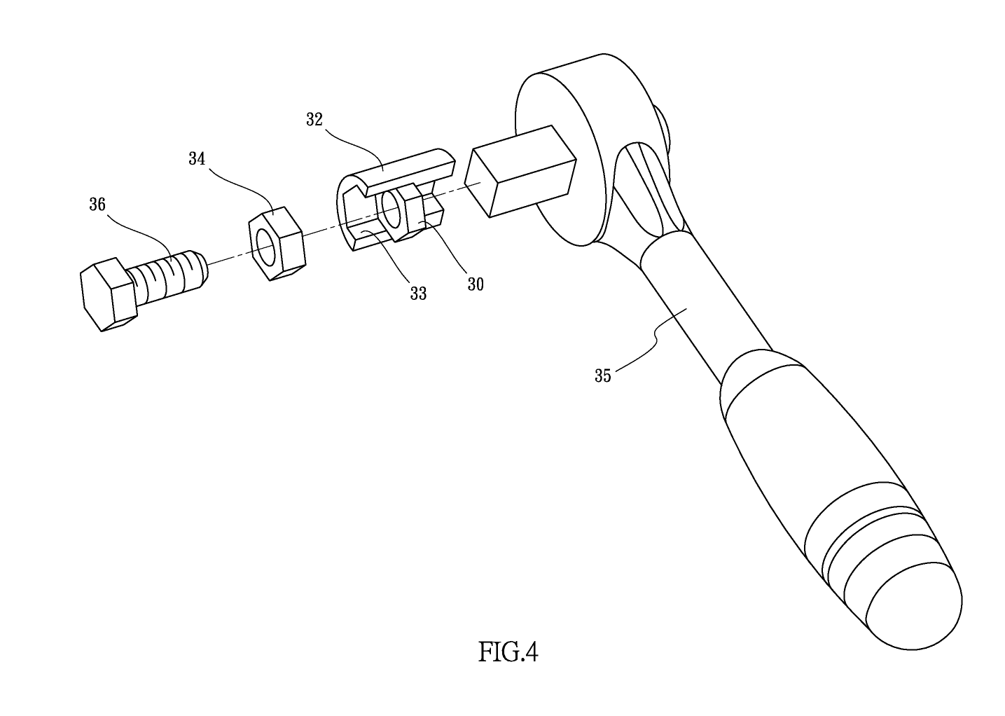

FIG. 5 shows yet another conventional fastening unit;

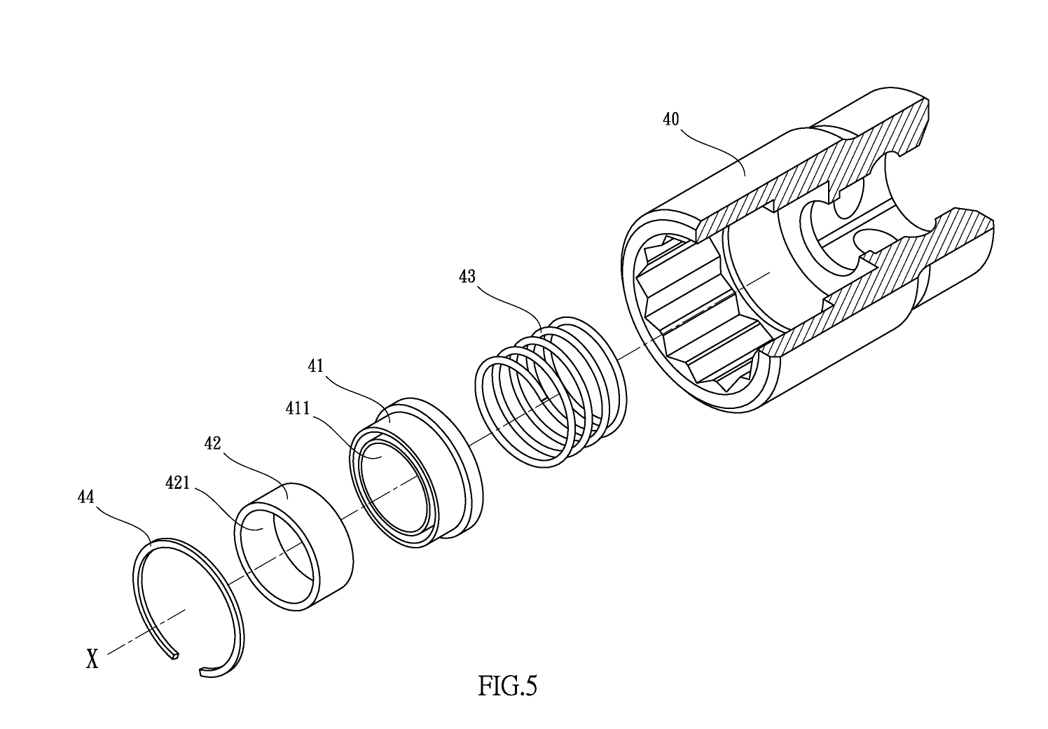

FIG. 6 is a cross sectional view to show the conventional fastening unit in FIG. 5 is used to fasten a nut to a bolt;

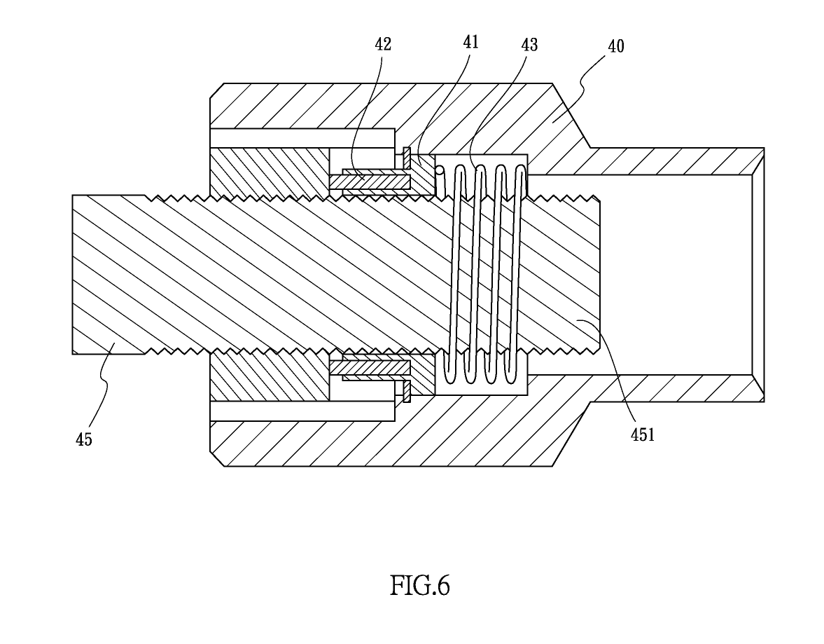

FIG. 7 is an exploded view of the fastening unit of the present invention and a ratchet wrench;

FIG. 8 is a cross sectional view to show the fastening unit of the present invention;

FIG. 9 is a cross sectional view to show that the fastening unit of the present invention is cooperated with a ratchet wrench to fasten a nut to a bolt;

FIG. 10 is an enlarged and cross sectional view to show that the nut is threadedly mounted to the bolt when using the fastening unit of the present invention to fasten the nut to the bolt;

FIG. 11 is an exploded view of the second embodiment of the fastening unit of the present invention;

FIG. 12 is a cross sectional view to show the second embodiment of the fastening unit of the present invention;

FIG. 13 is a cross sectional view to show that the second embodiment of the fastening unit of the present invention is cooperated with a ratchet wrench to fasten a nut to a bolt;

FIG. 14 shows the third embodiment of the fastening unit of the present invention, and

FIG. 15 is a cross sectional view to show that the third embodiment of the fastening unit of the present invention is cooperated with a ratchet wrench to fasten a nut to a bolt.

### DETAILED DESCRIPTION OF THE PREFERRED EMBODIMENT

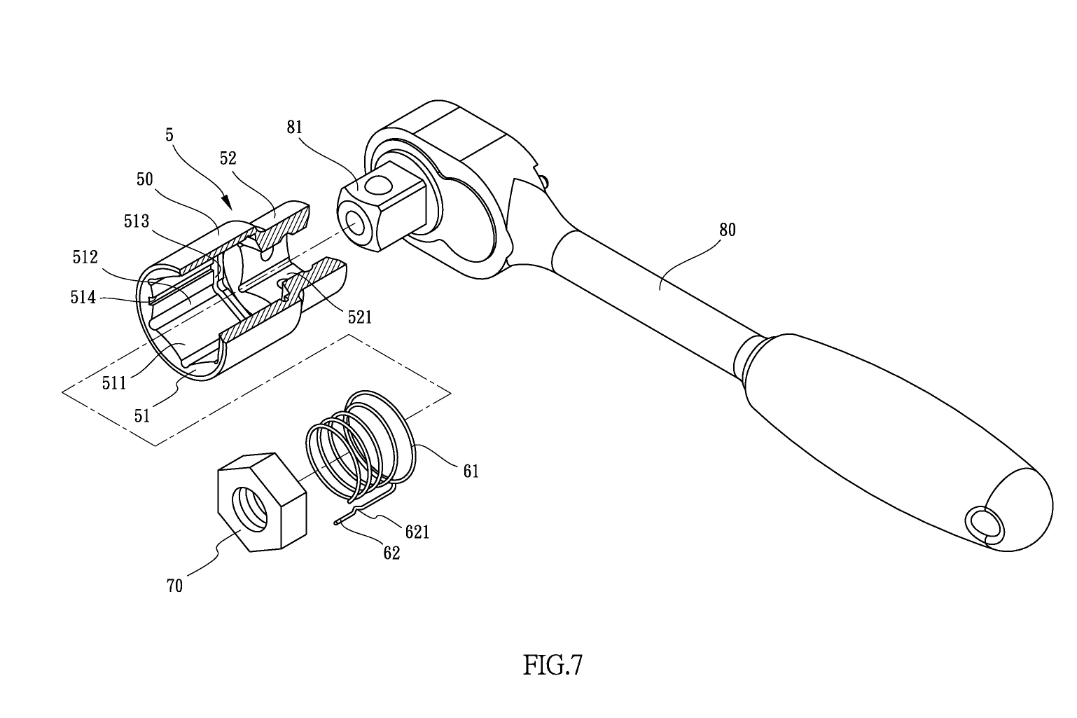

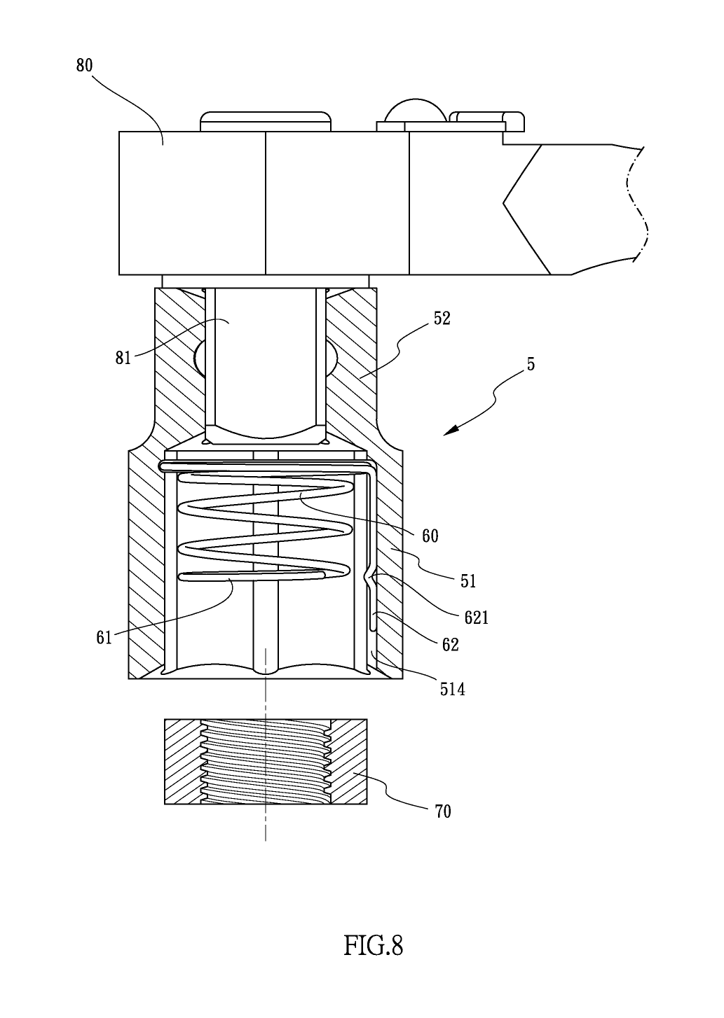

Referring to FIGS. 7 and 8, the fastening unit 5 of the present invention comprises a body 50 having a driving end 51 and a connection end 52 respectively on two ends thereof. The driving end 51 has a driving recess 511 defined therein for receiving a nut 70 therein. The connection end 52 has an engaging recess 521 defined therein which is to be connected with a driving portion 81 of a ratchet wrench 80. The driving recess 511 has a first slot 512 defined in the inside thereof and the first slot 512 extends along the X-axis of the body 50. An annular groove 513 is defined in the inner periphery of the inner end of the driving recess 511. A second slot 514 is defined in the inside of the driving recess 511 and the second slot 514 extends along the X-axis of the body 50. The annular groove 513 communicates with the first and second slots 512, 514.

A resilient member 60 has a spiral and cylindrical portion 61. The resilient member 60 has an extension end 62, and a protrusion 621 protrudes laterally from the extension end 62 so that the extension end 62 is a resilient end. The protrusion 621 applies a resilient force along the Y-axis of the body 50.

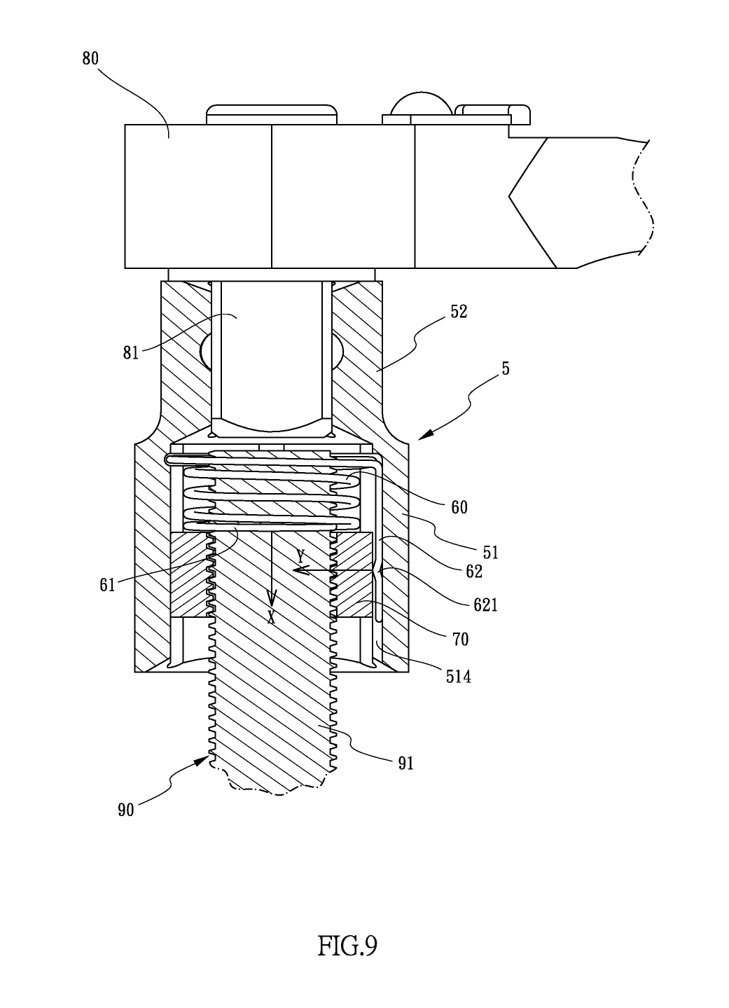

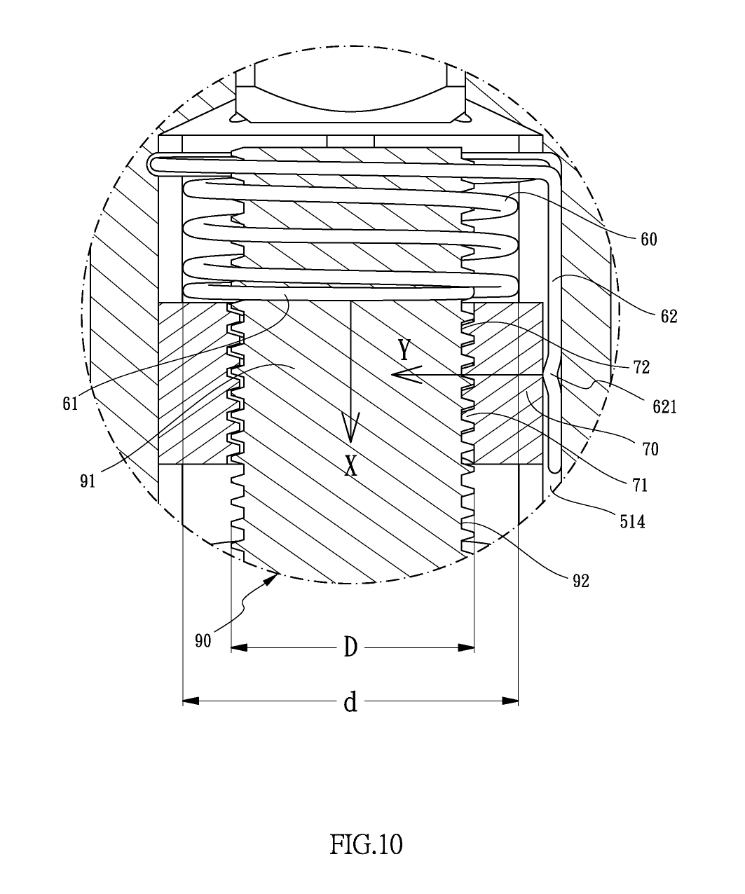

As shown in FIGS. 9 and 10, when in assembling, the lower end of the spiral and cylindrical portion 61 of the resilient member 60 is engaged with the annular groove 513. The extension end 62 is engaged with the second slot 514. The protrusion 621 protruding beyond the second slot 514.

When connecting the nut 70 to a bolt 90, the nut 70 is threaded to the shank 91 of the bolt 90, and the driving portion 81 of a ratchet wrench 80 is engaged with the connection recess 521. The driving end 511 is then mounted to the nut 70 which is biased by the spiral and cylindrical portion 61 which applies a resilient force to the nut 70 in the X-axis direction. The protrusion 621 of the resilient member 60 is also pushed into the second slot 514 by the nut 70, and the protrusion 621 applies a resilient force to the side of the nut 70 in the Y-axis direction as shown in FIG. 10. The nut 70 is applied by the resilient forces in both X-axis direction and the Y-axis direction, so that the male threads 70 of the nut 70 are securely engaged with the female threads 92 of the bolt 90. Therefore, the friction between the male threads 70 of the nut 70 and the female threads 92 of the bolt 90 is increased. The ratchet wrench 80 is then repeatedly rotated back and forth to rotate the body 50, such that the nut 70 can be threadedly connected to the root portion of the shank 91 of the bolt 90. The shortcoming of the conventional fastening unit is improved.

The nut 70 is applied by the resilient forces in both X-axis direction and the Y-axis direction, so that the male threads 70 of the nut 70 are securely engaged with the female threads 92 of the bolt 90. Therefore, the user does not have to rotate the nut 70 to a position close to the root portion of the shank 91 by hand. No magnet is needed for the fastening unit 5, the manufacturing cost is lowered. The resilient member 60 provides the resilient forces in both X-axis direction and the Y-axis direction, so that when the nut 70 is received in the driving recess 511 of the body 50, the nut 70 is easily threadedly engaged with the threads of the bolt 90 due to the larger friction.

It is noted that the minimum diameter “d” of the spiral and cylindrical portion 61 is equal to or larger than the diameter “D” of the shank 91 of the bolt 90. This restriction makes the resilient member 60 have maximum and even resilient force in the X-axis direction as shown in FIG. 10.

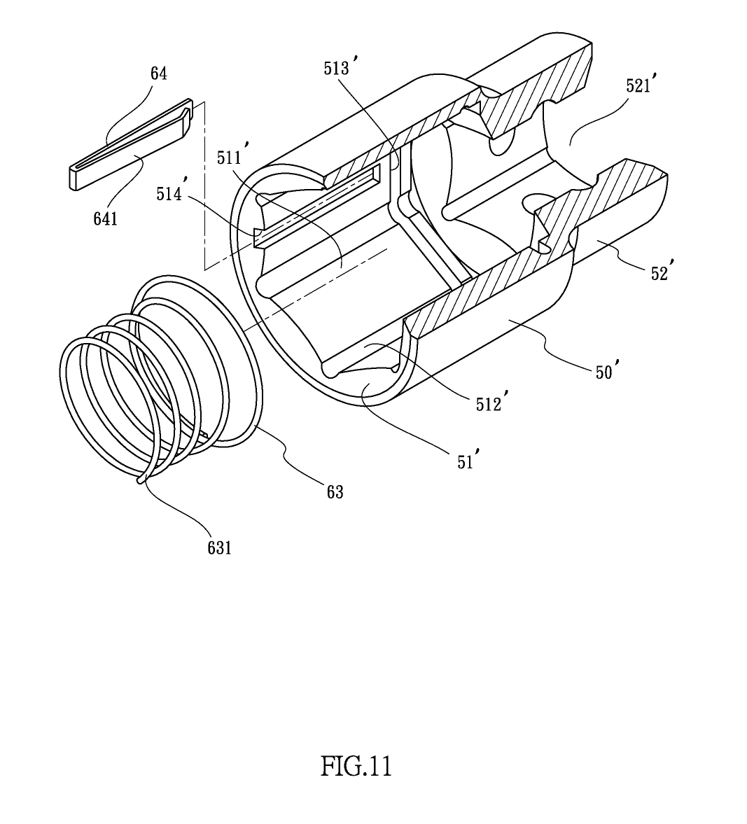

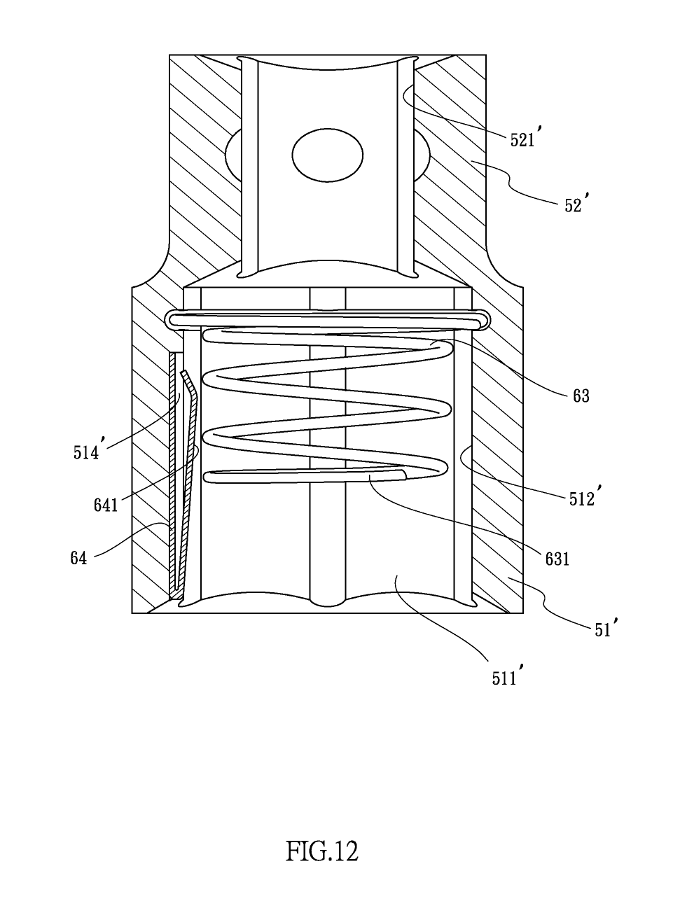

FIGS. 11 and 12 show the second embodiment of the fastening unit 50′ which comprises a body 50′ having a driving end 51′ and a connection end 52′ respectively on two ends thereof. The driving end 51′ has a driving recess 511′ defined therein which is used to receive a nut 70 therein. The connection end 52′ has an engaging recess 521′ defined therein. The driving recess 511′ has a first slot 512′ defined in the inside thereof and the first slot 512′ extends along the X-axis of the body 50′. An annular groove 513′ is defined in the inner periphery of the inner end of the driving recess 511′. A second slot 514′ is defined in the inside of the driving recess 511′ and the second slot 514′ extends along the X-axis of the body 50′. The annular groove 513′ communicates with the first and second slots 512′, 514′.

A first resilient member 63 has a spiral and cylindrical portion 631. The lower end of the spiral and cylindrical portion 631 is engaged with the annular groove 513′. The first resilient member 63 applies a resilient force along the X-axis of the body 50′.

A second resilient member 64 has a first part and a second part 641 whose one end is connected to one end of the first part at an angle. The first part of the second resilient member 64 is inserted in the second slot 514′, and the second part 641 applies a resilient force along the Y-axis of the body 50′.

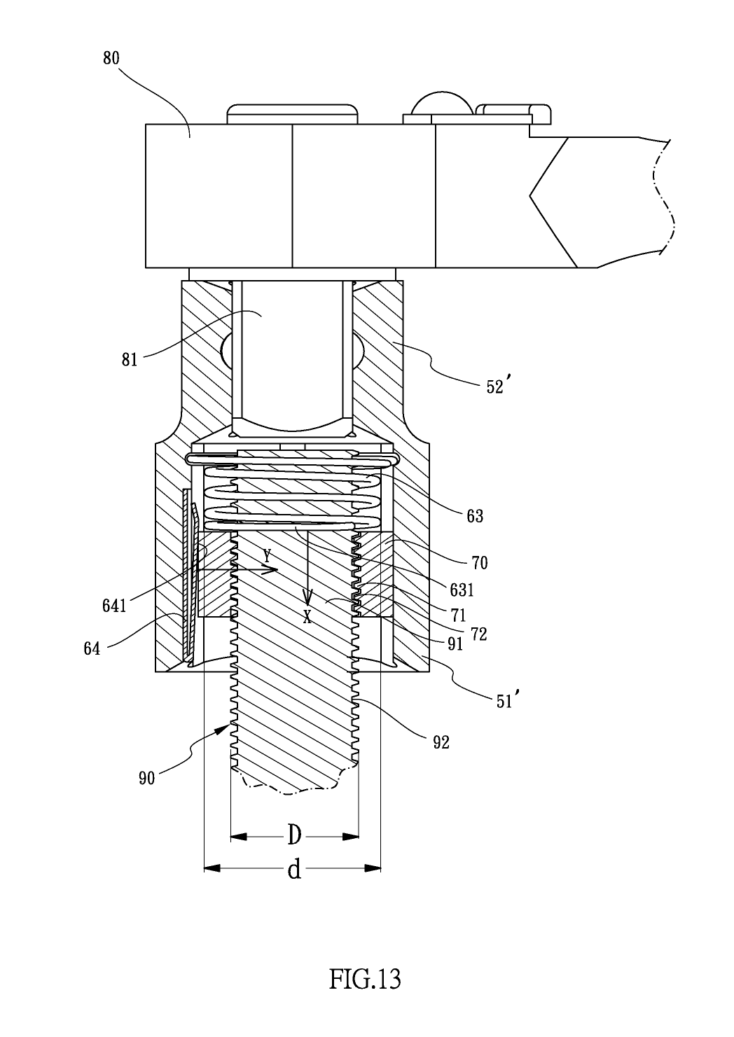

When connecting the nut 70 to a bolt 90, the nut 70 is threaded to the shank 91 of the bolt 90, and the driving portion 81 of a ratchet wrench 80 is engaged with the connection recess 521′. The driving end 511′ is then mounted to the nut 70 which is biased by the spiral and cylindrical portion 61 which applies a resilient force to the nut 70 in the X-axis direction. The second part 641 of the second resilient member 64 is also pushed inward by the nut 70, and the second part 641 applies a resilient force to the side of the nut 70 in the Y-axis direction as shown in FIG. 13. The nut 70 is applied by the resilient forces in both X-axis direction and the Y-axis direction, so that the male threads 70 of the nut 70 are securely engaged with the female threads 92 of the bolt 90. Therefore, the friction between the male threads 70 of the nut 70 and the female threads 92 of the bolt 90 is increased. The ratchet wrench 80 is then repeatedly rotated back and forth to rotate the body 50′, such that the nut 70 can be threadedly connected to the root portion of the shank 91 of the bolt 90. The shortcoming of the conventional fastening unit is improved.

It is noted that the minimum diameter “d” of the spiral and cylindrical portion 631 of the first resilient member 63 is equal to or larger than the diameter “D” of a shank 91 of a bolt 90. This restriction makes the first resilient member 60 have maximum and even resilient force in the X-axis direction as shown in FIG. 13.

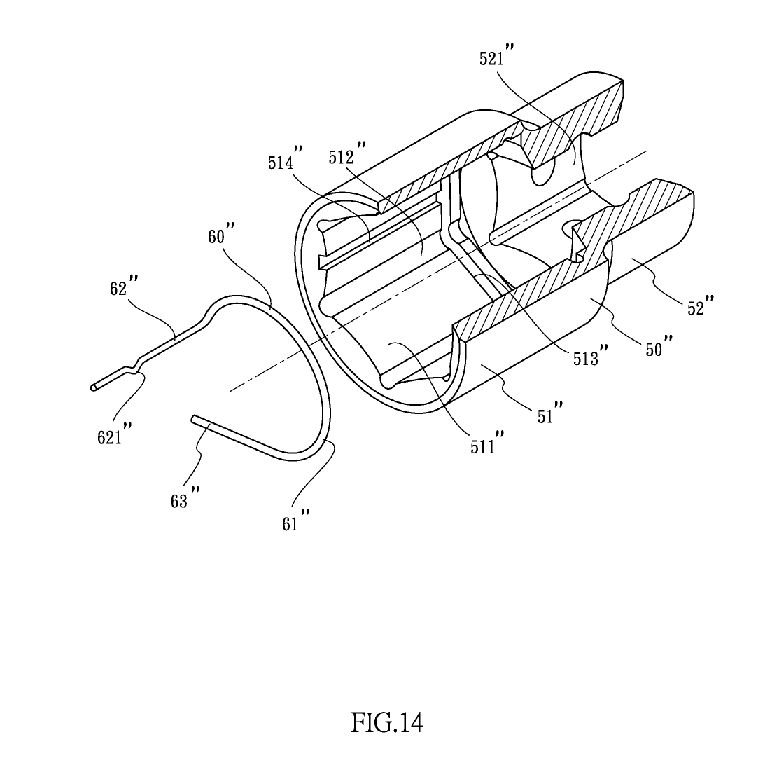

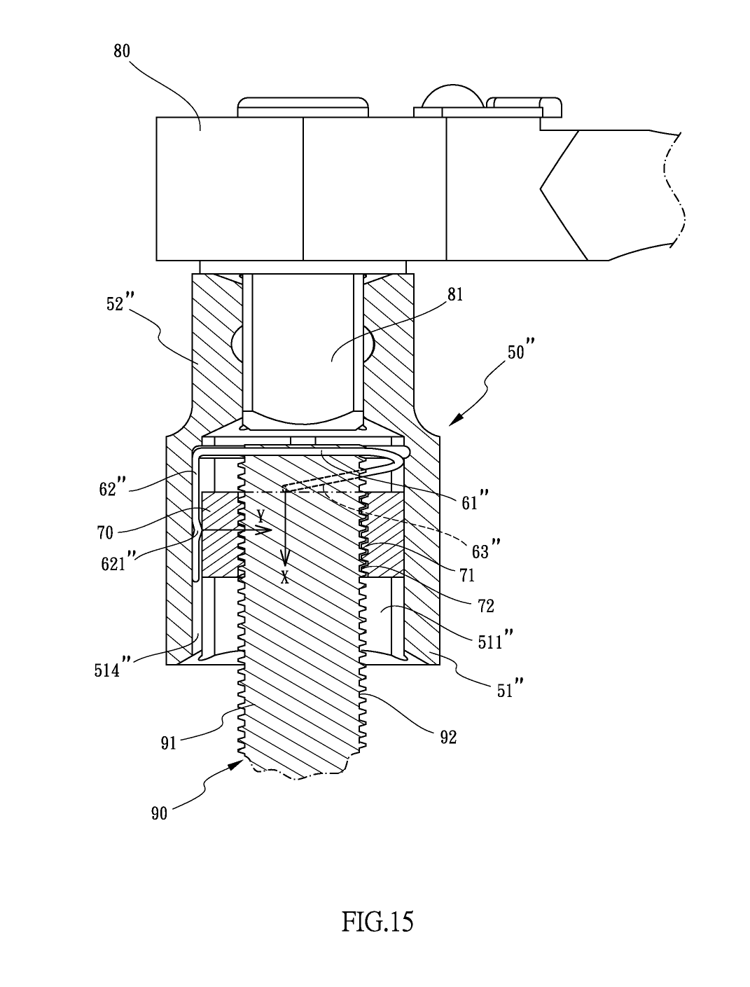

FIGS. 14 and 15 show the third embodiment of the fastening unit 5″ of the present invention and comprises a body 50″ having a driving end 51″ and a connection end 52″ respectively on two ends thereof. The driving end 51″ has a driving recess 511″ defined therein. The connection end 52″ has an engaging recess 521″ defined therein which is used to be connected with a driving portion 81 of a ratchet wrench 80.

The driving recess 511″ has a first slot 512″ defined in the inside thereof and the first slot 512″ extends along the X-axis of the body 50″. An annular groove 513″ is defined in the inner periphery of the inner end of the driving recess 511″. A second slot 514″ is defined in the inside of the driving recess 511″ and the second slot 514″ extends along the X-axis of the body 50″. A resilient member 60″ has a C-shaped portion 61″ which has an extension end 62″ and a distal end 63″. The extension end 62″ has a protrusion 621″ protruding laterally from the extension end 62″. The C-shaped portion 61″ is engaged with the annular groove 513″. The extension end 62″ is engaged with the second slot 514″ and the protrusion 621″ extends beyond the second slot 514″. The distal end 63″ extends along the X-axis of the driving recess 511″ and spirally located at a distance from the annular groove 513″. The distal end 63″ applies a resilient force along the X-axis of the body 50. The extension end 62″ is a resilient end and the protrusion 621″ applies a resilient force along a Y-axis of the body 50″. The annular groove 513″ communicates with the first and second slots 512″, 514″.

When connecting the nut 70 to a bolt 90, the nut 70 is threaded to the shank 91 of the bolt 90, and the driving portion 81 of a ratchet wrench 80 is engaged with the connection recess 521″. The driving end 511″ is then mounted to the nut 70 which is biased by the distal end 63″ which applies a resilient force to the nut 70 in the X-axis direction. The protrusion 621″ of the extension end 62″ is also pushed inward by the nut 70, and the protrusion 621″ applies a resilient force to the side of the nut 70 in the Y-axis direction as shown in FIG. 15. The nut 70 is applied by the resilient forces in both X-axis direction and the Y-axis direction, so that the male threads 70 of the nut 70 are securely engaged with the female threads 92 of the bolt 90. Therefore, the friction between the male threads 70 of the nut 70 and the female threads 92 of the bolt 90 is increased. The ratchet wrench 80 is then repeatedly rotated back and forth to rotate the body 50″, such that the nut 70 can be threadedly connected to the root portion of the shank 91 of the bolt 90. The nut 70 can be threadedly connected to the root portion of the shank 91 of the bolt 90.

While we have shown and described the embodiment in accordance with the present invention, it should be clear to those skilled in the art that further embodiments may be made without departing from the scope of the present invention.

What is claimed is:

1. A fastening unit comprising:
a body having a driving end and a connection end respectively on two ends thereof, the driving end having a driving recess defined therein which is adapted to receive a nut therein, the connection end having an engaging recess defined therein which is adapted to be connected with a driving portion of a ratchet wrench, the driving recess having a first slot defined in an inside thereof and the first slot extending along an X-axis of the body, an annular groove defined in an inner periphery of an inner end of the driving recess, a second slot defied in the inside of the driving recess and the second slot extending along the X-axis of the body, and
a resilient member having a spiral and cylindrical portion, the resilient member having an extension end and a protrusion protruding laterally from the extension end so that the extension end is a resilient end, the protrusion applying a resilient force along a Y-axis of the body.

2. The fastening unit as claimed in claim 1, wherein a minimum diameter of the spiral and cylindrical portion is equal to or larger than a diameter of a shank of a bolt.

3. A fastening unit comprising:
a body having a driving end and a connection end respectively on two ends thereof, the driving end having a driving recess defined therein which is adapted to receive a nut therein, the connection end having an engaging recess defined therein, the driving recess having a first slot defined in an inside thereof and the first slot extending along an X-axis of the body, an annular groove defined in an inner periphery of an inner end of the driving recess, a second slot defined in the inside of the driving recess and the second slot extending along the X-axis of the body;
a first resilient member having a spiral and cylindrical portion, an end of the spiral and cylindrical portion engaged with the annular groove, the first resilient member applying a resilient force along the X-axis of the body, and
a second resilient member having a first part and a second part whose one end is connected to one end of the first part at an angle, the first part of the second resilient member inserted in the second slot, the second part applying a resilient force along a Y-axis of the body.

4. The fastening unit as claimed in claim 3, wherein a minimum diameter of the spiral and cylindrical portion of the first resilient member is equal to or larger than a diameter of a shank of a bolt.

5. A fastening unit comprising:
a body having a driving end and a connection end respectively on two ends thereof, the driving end having a driving recess defined therein, the connection end having an engaging recess defined therein which is adapted to be connected with a driving portion of a ratchet wrench;
the driving recess having a first slot defined in an inside thereof and the first slot extending along an X-axis of the body, an annular groove defined in an inner periphery of an inner end of the driving recess, a second slot defied in the inside of the driving recess and the second slot along the X-axis of the body, and
a resilient member having a C-shaped portion which has an extension end and a distal end, the extension end having a protrusion protruding laterally from the extension end, the distal end applying a resilient force along the X-axis of the body, the extension end being a resilient end and the protrusion applying a resilient force along a Y-axis of the body.
